(19) United States
(12) Patent Application Publication
(10) Pub. No.: US 2025/0317775 A1
(43) Pub. Date: Oct. 9, 2025

(54) MANAGING MEASUREMENT GAP CONFIGURATION FOR POSITIONING MEASUREMENT

(71) Applicant: GOOGLE LLC, Mountain View, CA (US)

(72) Inventor: Chih-Hsiang Wu

(21) Appl. No.: 18/865,254

(22) PCT Filed: May 9, 2023
(86) PCT No.: PCT/US23/66798

§ 371 Date: Nov. 12, 2024

(51) Int. Cl. H04W 24/10; H04L 5/00; H04W 64/00

(52) U.S. Cl. CPC H04W 24/10; H04L 5/0051; H04W 64/00

(57) ABSTRACT

To configure reference signal measurements at a user equipment (UE), a central unit (CU) of a distributed base station that also includes a distributed unit (DU) transmits (504), to the DU, a first message including a request to configure a measurement gap for a UE; receives (507), from the DU, a second message including a measurement gap configuration; and provides (512) the measurement gap configuration to the UE, for use with the reference signal measurements.

### CROSS-REFERENCE TO RELATED APPLICATION

This application claims priority to and the benefit of the filing date of provisional U.S. Patent Application No. 63/339,966, entitled “Managing Measurement Gap Configuration for Positioning Measurement,” filed on May 9, 2022. The entire contents of the provisional application are hereby expressly incorporated herein by reference.

### FIELD OF THE DISCLOSURE

This disclosure relates generally to wireless communications and, more particularly, to managing gap configuration(s) for positioning measurement.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Location Services (LCS) allow a user equipment unit (UE) and/or a base station to determine the geographic location of the UE when, for example, the UE is not capable of determining its location due to limited hardware capability, the UE receives insufficient satellite or other beacon signals, or the base station attempts to locate the UE in an emergency situation.

Entities that support LCS in a core network (CN) include a Location Management Function (LMF) and an Evolved Serving Mobile Location Center (E-SMLC), for example. In some examples, a UE exchanges messages with an LMF using a positioning protocol, such as the LTE positioning protocol (LPP). Similarly, a UE sends LPP messages to an access management function (AMF) operating in a CN, in an uplink (UL) non-access stratum (NAS) Transport message. The AMF in turn sends the LPP messages to the LMF or E-SMLC. In the downlink direction, the AMF sends LPP messages from the LMF or E-SMLC to the UE using downlink (DL) NAS Transport messages.

Preconfigured measurement gap procedures are specified for positioning measurement. More specifically, the LMF transmits a Measurement Preconfiguration Required message to a gNB to request the gNB to configure a preconfigured measurement gap for the UE. After or in response to receiving the Measurement Preconfiguration Required message, the gNB transmits an RRC reconfiguration message including a preconfigured measurement gap configuration to the UE. Later in time, when the gNB receives a Measurement Activation message from the LMF or receives a UL MAC control element requesting activation of the measurement configuration, the gNB transmits a Positioning Measurement Gap Activation Command to the UE to activate the preconfigured measurement gap configuration. In response to or after receiving the Positioning Measurement Gap Activation Command, the UE activates the preconfigured measurement gap configuration and uses the preconfigured measurement configuration to perform measurements on DL reference signal (e.g., positioning reference signal (PRS) for positioning. However, it is not clear how to configure and activate a preconfigured measurement gap in a distributed base station. Besides, it is also not clear how to deactivate and/or release a preconfigured measurement gap configuration in a distributed base station.

### SUMMARY

An example embodiment of the techniques of this disclosure is a method for configuring reference signal measurements at a UE. The method is implemented in a central unit (CU) of a distributed base station that also includes a distributed unit (DU), and comprises transmitting, to the DU, a first message including a request to configure a measurement gap for a UE; receiving, from the DU, a second message including a measurement gap configuration; and providing the measurement gap configuration to the UE, for use with the reference signal measurements.

Another example embodiment of these techniques is a method for configuring reference signal measurements at a UE, the method implemented in a DU of a distributed base station that also includes a CU. The method comprises receiving, from the CU, a first message including a request to configure a measurement gap for a UE; and transmitting, to the CU, a second message including a measurement gap configuration.

Another example embodiment of these techniques is a radio access network (RAN) node comprising processing hardware and configured to implement one of the methods above.

### BRIEF DESCRIPTION OF THE DRAWINGS

FIG. 1A is a block diagram of an example wireless communication system in which a user device and a base station of this disclosure can implement the techniques of this disclosure for managing small data transmission;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU; and

FIG. 3A illustrates an example scenario in which a DU and a CU transmit gap configurations and information for activating and performing gap measurements;

FIG. 3B illustrates an example scenario similar to FIG. 3A, but in which the CU requests the gap configurations from the DU in a request message;

FIG. 3C illustrates an example scenario similar to FIG. 3A, but in which the DU transmits the gap configurations in a measurement preconfiguration confirmation response;

FIG. 3D illustrates an example scenario similar to FIG. 3A, but in which the UE deactivates gap configurations after activating the configurations and/or performing measurements using such;

FIG. 3E illustrates an example scenario similar to FIG. 3A, but in which the CU and DU transmit messages to release the gap configurations at the UE;

FIG. 3F illustrates an example scenario similar to FIG. 3E, but in which the DU determines to release the gap configurations at the UE;

FIG. 4A is a flow diagram of an example method implemented in a DU for transmitting a gap configurations to a CU and then transmits a measurement gap activation command to the UE after receiving a response from the CU;

FIG. 4B is a flow diagram of an example method similar to FIG. 4A, but in which the DU receives a request from the CU for the gap configurations;

FIG. 4C is a flow diagram of an example method similar to FIG. 4A, but in which the DU transmits the gap configurations to the CU and then transmits the activation command to the UE;

FIG. 5A is a flow diagram of an example method implemented in a CU for receiving gap configurations from a DU and transmitting a response to the CU including the gap configurations;

FIG. 5B is a flow diagram of an example method similar to FIG. 5A, but in which the CU transmits a request to the DU for the gap configurations and receives the configurations from the DU;

FIG. 5C is a flow diagram of an example method similar to FIG. 5A, but in which the CU receives the gap configurations from the DU in response to a request to configure the measurement gap for the UE;

FIG. 6 is a flow diagram of an example method implemented in a CU for determining whether to transmit a first or second set measurement gap information based on whether the measurement gap is for positioning measurements.

FIG. 7A is a flow diagram of an example method implemented in a CU for receiving a message from a DU including gap release information and transmitting a message including the gap release information to the UE via the DU;

FIG. 7B is a flow diagram of an example method similar to FIG. 7A, but in which the CU generates the release information for releasing gap configurations at the UE; and

FIG. 8 is a flow diagram of an example method implemented in a DU for receiving a message from the CU to release gap configurations for the UE and transmitting the release information to the UE.

### DETAILED DESCRIPTION OF THE DRAWINGS

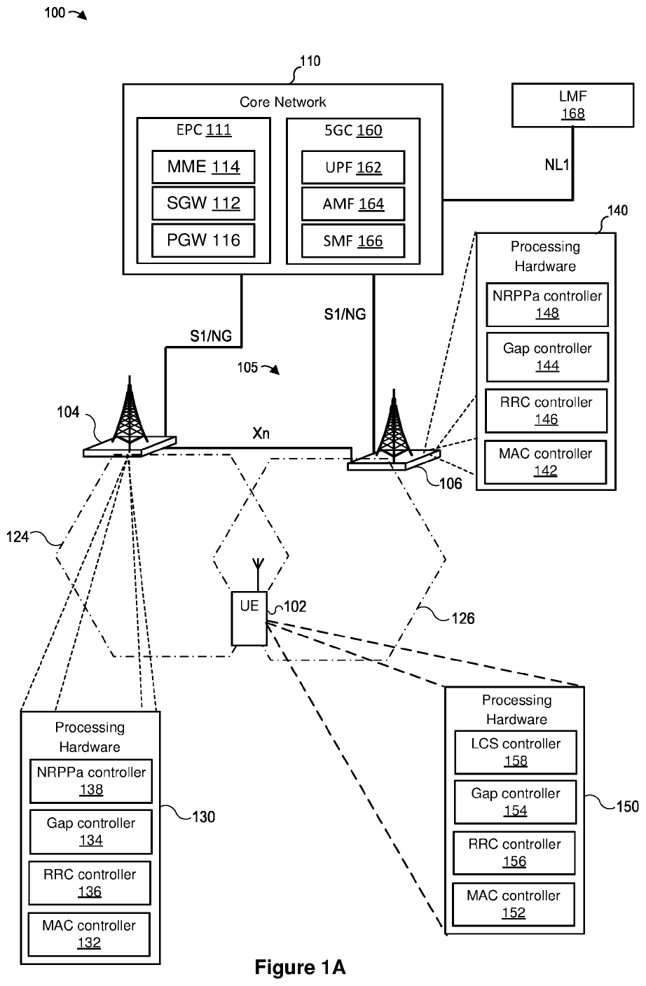

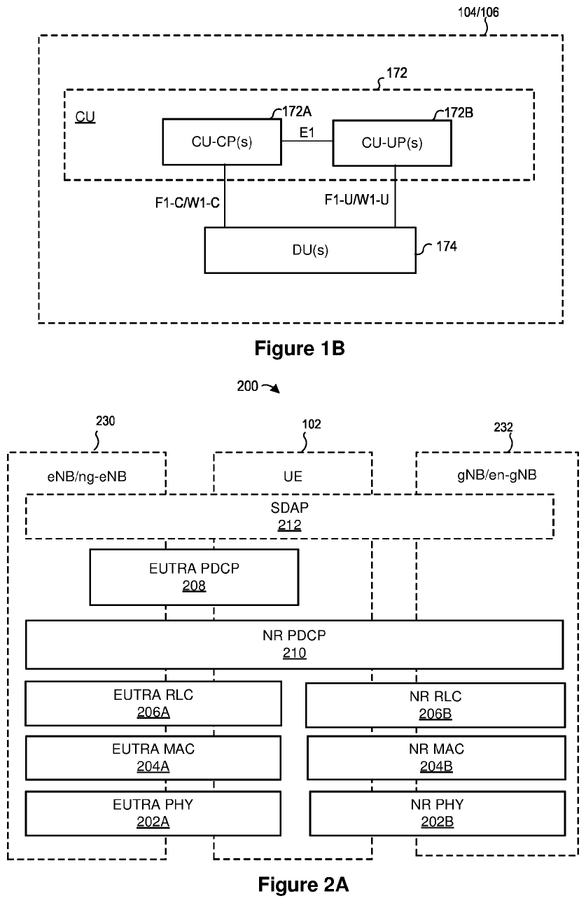

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

A location management function (LMF) 168 manages the support of different location services for UEs, including positioning of the UEs and delivery of assistance data to the UEs. The LMF 168 is interconnected with the AMF 164 via an interface (e.g., NL1 interface). The LMF 168 may interact with a base station (e.g., the base station 104 or 106) for a UE (e.g., the UE 102) in order to obtain position measurements for the UE, including uplink measurements made by the base station and downlink measurements made by the UE that were provided to the base station. The LMF may interact with the UE in order to deliver assistance data to the UE (if requested by the UE) for a particular location service, or to obtain a location estimate.

The LMF 168 may interact with multiple base stations (e.g., base stations 104 and 106) to provide assistance data information for broadcasting. The assistance data information for broadcast may optionally be segmented and/or ciphered by the LMF 168. The LMF 168 may also interact with AMFs to provide ciphering key data information to the AMF as described in greater detail in TS 23.273.

For positioning of a UE, the LMF 168 decides on one or more position methods to be used, based on factors that may include a LCS client type, a required QoS, UE positioning capabilities of the UE, and positioning capabilities of a base station serving the UE. The LMF 168 then invokes the positioning method(s) in the UE and/or base station. The positioning methods may yield a location estimate for UE-based position methods and/or positioning measurements for UE-assisted and network-based position methods. The LMF 168 may combine all the received results and determine a single location estimate for the UE (hybrid positioning). Additional information like accuracy of the location estimate and velocity may also be determined.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a measurement gap controller 134 configured to manage measurement gaps for one or more UEs communicating with the base station 104. The processing hardware further can include an RRC controller 136 to implement procedures and messaging at the RRC sublayer of the protocol communication stack. The processing hardware 130 in an example implementation includes an NRPPa controller 138 configured to manage communications with the LMF 168 via a NR Positioning Protocol A (NRPPa) to enable positioning and location services for one or more UEs. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC controller 156 configured to manage procedures and messaging at the RRC sublayer of the protocol communication stack. The processing hardware 150 in an example implementation includes an LCS controller 158 that generates outbound (uplink) messages related to positioning, processes inbound (downlink) messages related to positioning, and executes various procedures related to positioning. The processing hardware 150 in an example implementation includes a Medium Access Control (MAC) controller 152 configured to perform a random access procedure with a base station, transmit uplink MAC protocol data units (PDUs) and/or control elements to the base station, and receive downlink MAC PDUs and/or control elements from the base station. The processing hardware 150 can also include a measurement gap controller 154 configured to manage measurement gap(s) configured by the RAN 105. The processing hardware further can include an RRC controller 156 to implement procedures and messaging at the RRC sublayer of the protocol communication stack.

FIG. 1B depicts an example distributed or disaggregated implementation of any one or more of the base stations 104, 106. In this implementation, the base stations 104, 106 include a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 includes a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 includes a logical node CU-CP 172A that hosts the control plane part of the PDCP protocol of the CU 172. In further implementations, the CU 172 includes a logical node CU-UP 172B that hosts the user plane part of the PDCP protocol and/or Service Data Adaptation Protocol (SDAP) protocol of the CU 172. Depending on the implementation, the CU-CP 172A transmits control information (e.g., RRC messages, F1 application protocol messages), and the CU-UP 172B transmits the data packets (e.g., SDAP PDUs or Internet Protocol packets).

The CU-CP 172A can connect to multiple CU-UP 172B through the E1 interface. The CU-CP 172A selects the appropriate CU-UP 172B for the requested services for the UE 102. In some implementations, a single CU-UP 172B connects to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 connects to multiple CU-UP 172B under the control of the same CU-CP 172A. In such implementations, the CU-CP 172A establishes the connectivity between a CU-UP 172B and a DU 174 by using Bearer Context Management functions.

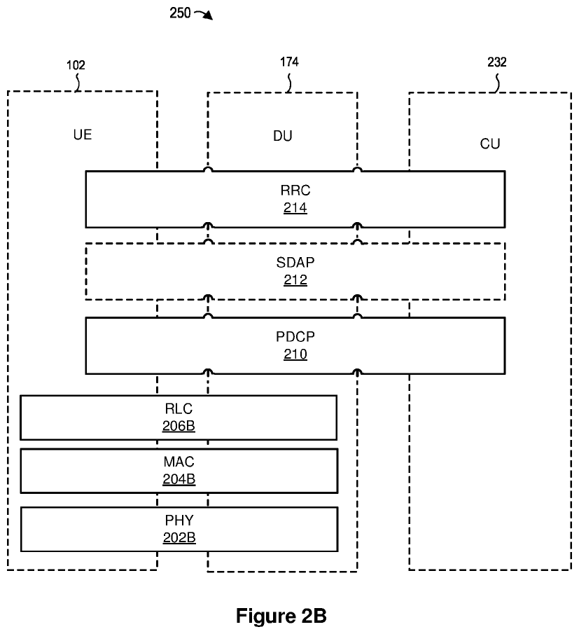

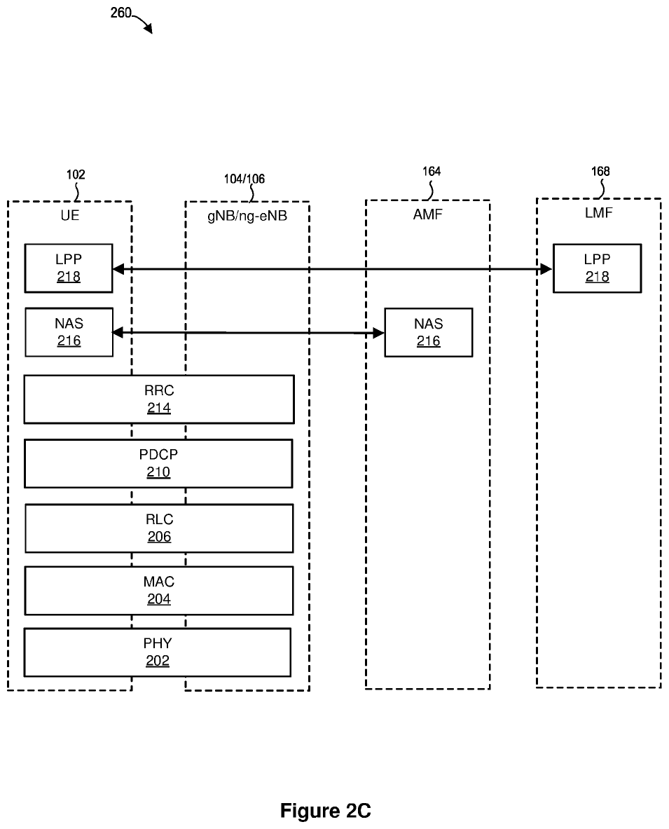

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. In some implementations, the NR PDCP sublayer 210 then provides data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

In some implementations, on a control plane, the EUTRA PDCP sublayer 208 and the NR PDCP sublayer 210 provides signaling radio bearers (SRBs) or RRC sublayer (not shown in FIG. 2A) to exchange RRC messages, non-access-stratum (NAS) messages or LPP messages, for example. In further implementations, on a user plane, the EUTRA PDCP sublayer 208 and the NR PDCP sublayer 210 provides Data Radio Bearers (DRBs) to support data exchange. Data exchanged on the NR PDCP sublayer 210 can be SDAP PDUs, Internet Protocol (IP) packets, or Ethernet packets.

FIG. 2B illustrates, in a simplified manner, an example protocol stack 250, via which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

Now referring to FIG. 2C, in a known wireless communication system, a UE and a gNB/ng-eNB support a physical layer (PHY) 202 of EUTRA or NR. The PHY layer 202 provides transport channels to the Medium Access Control (MAC) 204 sublayer, which in turn provides logical channels to the Radio Link Control (RLC) sublayer 206, and the RLC sublayer provides RLC channels to the Packet Data Convergence Protocol (PDCP) sublayer 210. The sublayer 210 PDCP sublayer provides signaling radio bearers (SRBs) and/or data radio bearers (DRBs) to the radio resource control (RRC) sublayer 210.

The UE and the AMF operating in the core network exchange messages of a non-access stratum (NAS) sublayer 216 via the gNB/ng-eNB, and the UE and the LMF, also operating in the core network, exchange messages of an LPP layer 218 via the gNB/ng-eNB and the AMF. In other words, the UE and LMF encapsulate LPP messages in NAS messages, and encapsulate NAS messages in RRC messages. The gNB/ng-eNB according to this architecture provides tunneling to the layers 216 and 218, and does not route or otherwise process messages at the layers 216, 218.

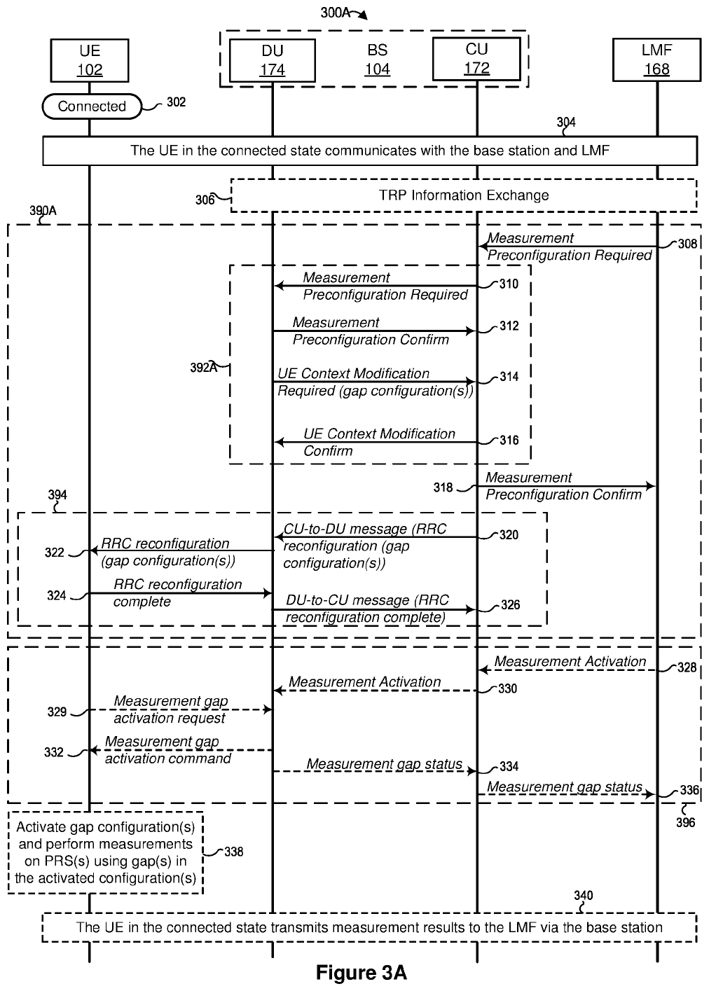

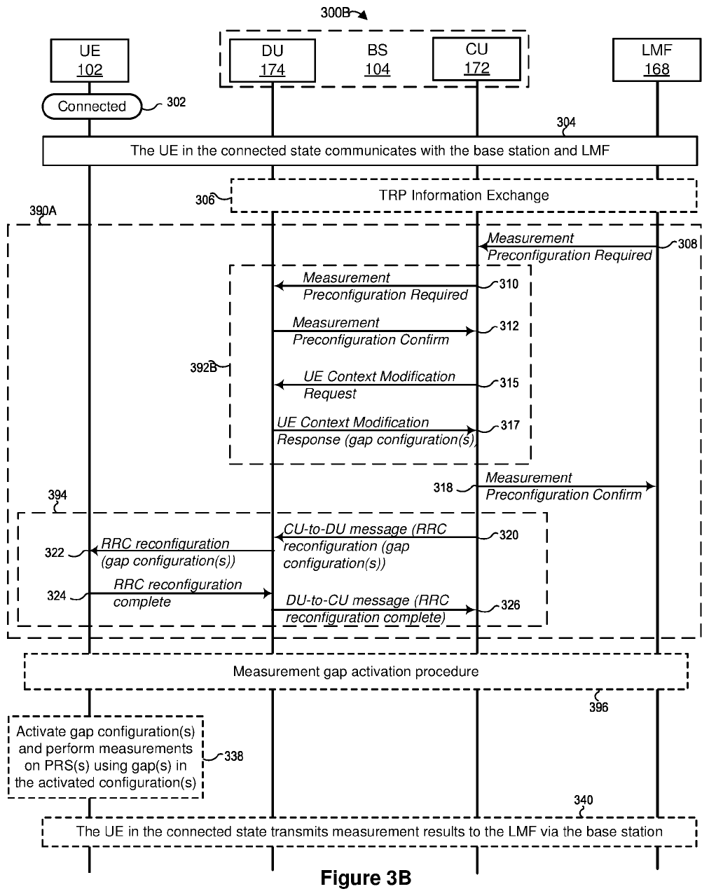

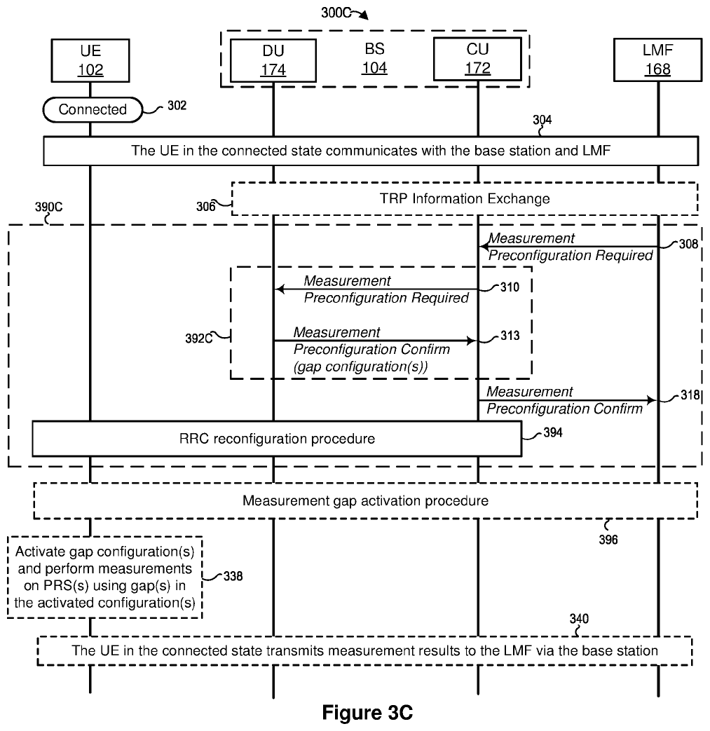

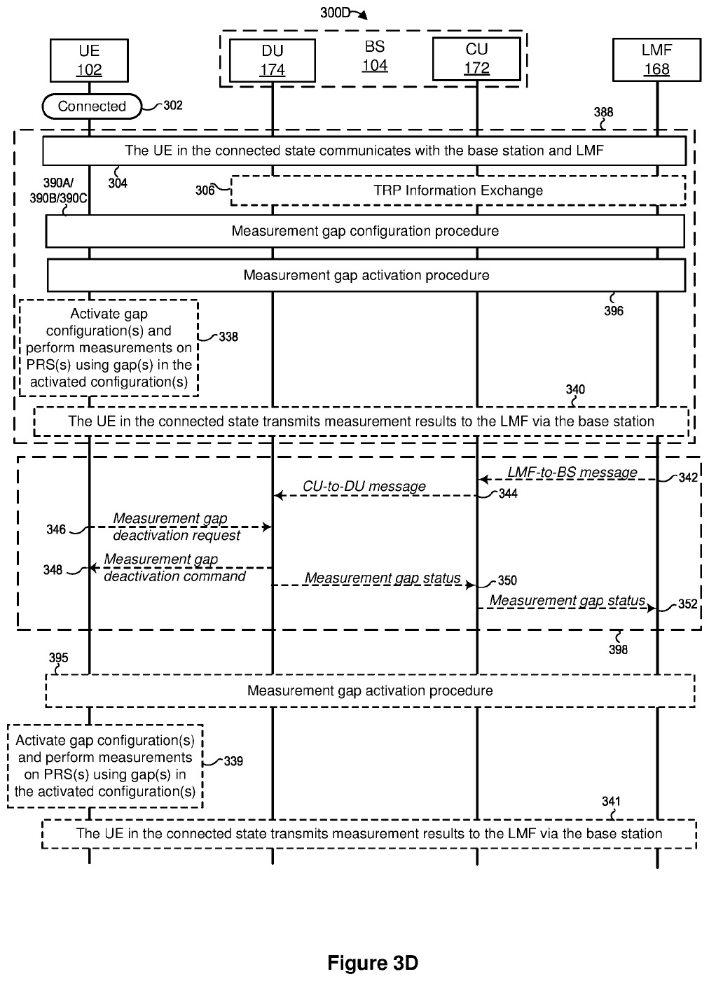

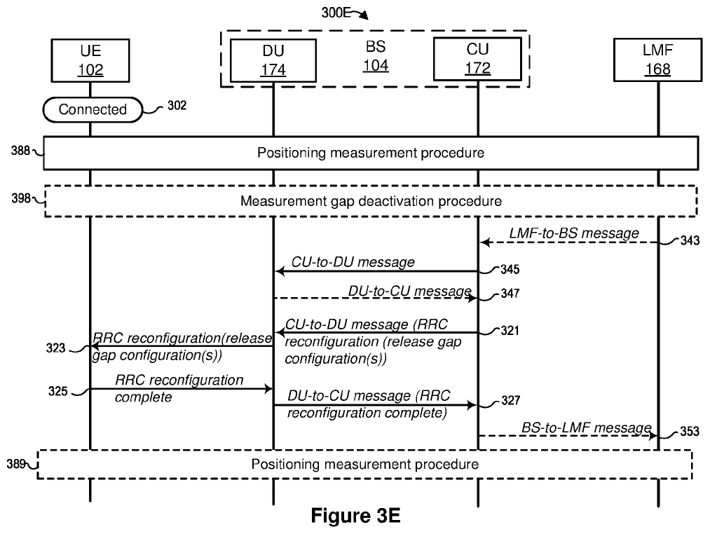

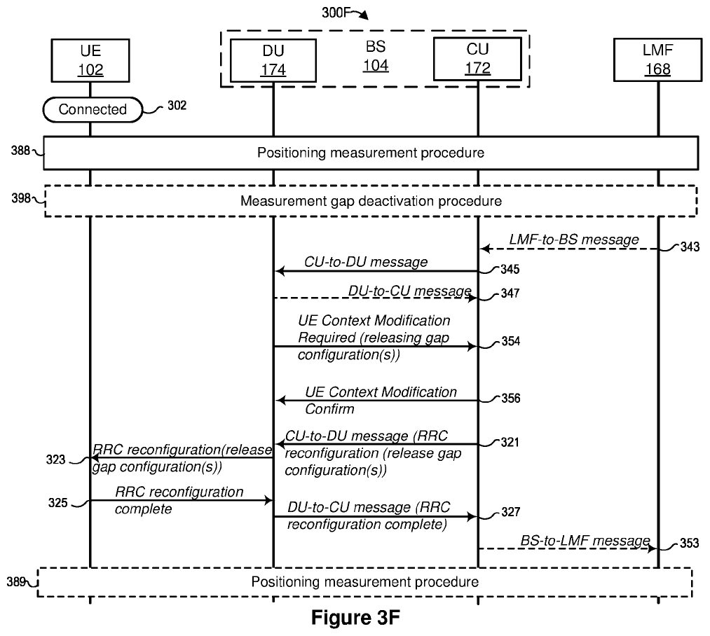

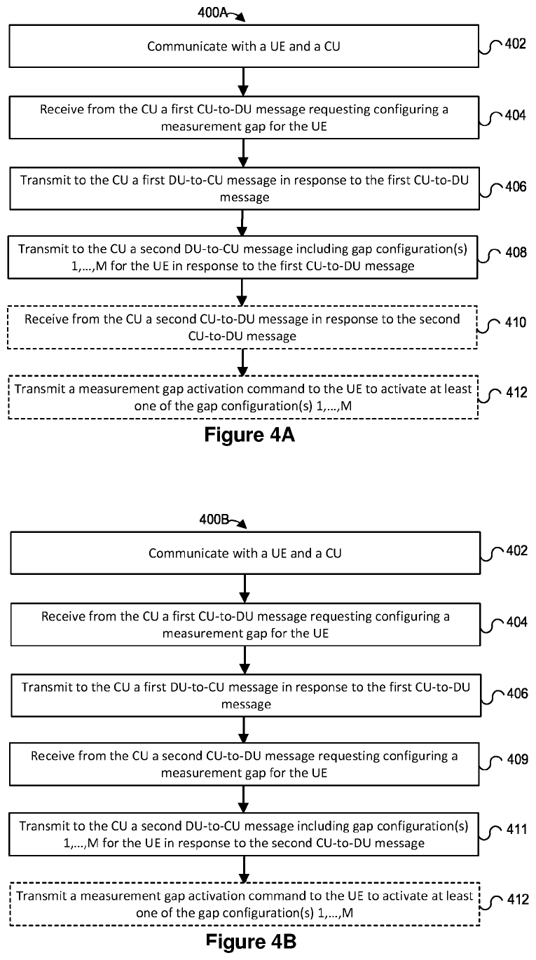

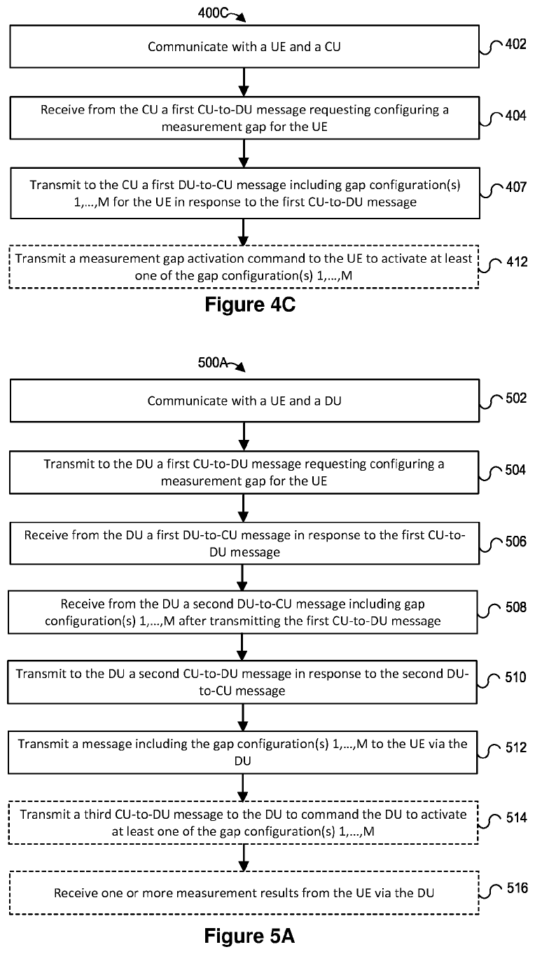

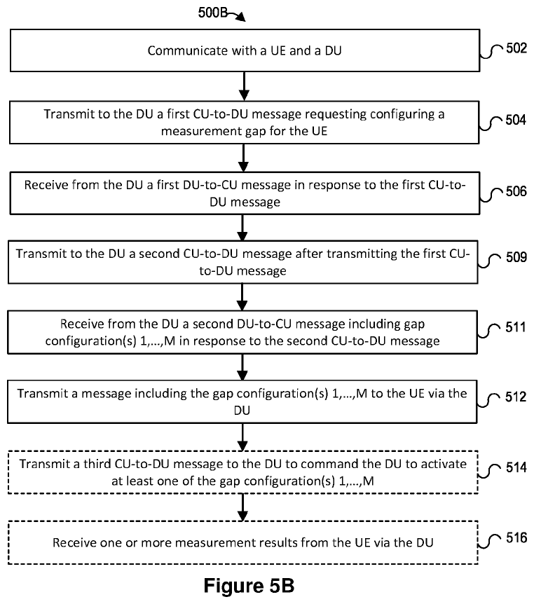

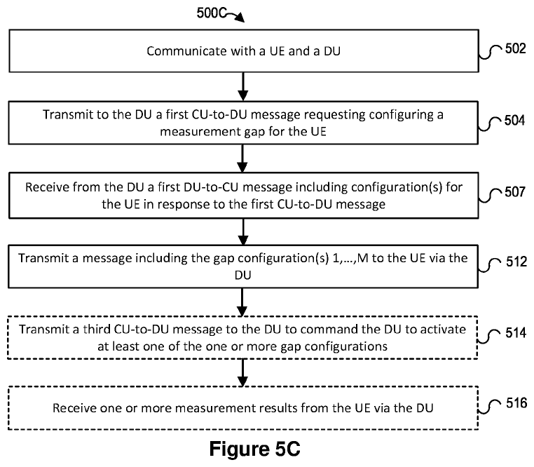

Next, several example scenarios that involve several components of FIG. 1A and relate to transmitting data in an inactive or idle state are discussed next with reference to FIGS. 3A-5C. Generally speaking, similar events in FIGS. 3A-5C are labeled with the similar reference numbers (e.g., event 302 in FIG. 3A is similar to event 302 in FIGS. 3B-3G, event 402 in FIGS. 4A-4C and event 502 in FIGS. 5A-5C), with differences discussed below where appropriate. With the exception of the differences shown in the figures and discussed below, any of the alternative implementations discussed with respect to a particular event (e.g., for messaging and processing) may apply to events labeled with similar reference numbers in other figures and also to both integrated and distributed base stations.

To simplify the following description, the “inactive state” is used and can represent the RRC_INACTIVE or RRC_IDLE state, and the “connected state” is used and can represent the RRC_CONNECTED state.

Referring first to FIG. 3A, which illustrates a scenario 300A in which the base station 104 includes a central unit (CU) 172 and a distributed unit (DU) 174. Depending on the implementation, the DU 174 operates one or more Transmission-Reception Point(s) (TRP(s)) (not shown in FIG. 3A). In the scenario 300, the UE 102 initially operates in a connected state 302 and communicates 304 with the DU 174, such as by using a DU configuration. While communicating 304 with the DU 174, the UE 102 uses a cell radio network temporary identifier (C-RNTI) to receive uplink grants and downlink assignments from the DU 174. The UE 102 transmits UL data to the DU 174 using the uplink grants and receives DL data from the DU 174 using the downlink assignments. The UE 102 further communicates 304 with the CU 172 via the DU 174 by using a CU configuration. The UE 102 communicates 304 LPP messages with the LMF 168 via the CU 172 and DU 174. In some implementations, the CU 172 exchanges the LPP messages with the LMF 168 directly or via the AMF 164. Before or while the UE communicates 304 with the base station 104, depending on the implementation, the LMF 68 performs 306 a TRP Information Exchange procedure with the base station 104 to obtain detailed information for TRPs hosted by the base station 104.

In some implementations, the LMF 168 transmits a TRP Information Request message (i.e., LMF-to-BS message or NRPPa message) to the CU 172 to perform the TRP Information Exchange procedure. In response to or after receiving the LMF-to-BS message, the CU 172 transmits at least one TRP Information Request message (i.e., CU-to-DU message(s) or F1AP message(s)) to the DU 174 to request the DU 174 to provide detailed information for TRP(s) hosted by the DU 174. In response to each of the CU-to-DU messages, the DU 174 transmits a TRP Information Response message (i.e., DU-to-CU message or F1AP message) including TRP information of a particular TRP to the CU 172. In some implementations, the CU 172 transmits at least one TRP Information Request message (i.e., CU-to-DU message(s) or F1AP message(s)) to other DU(s) (not shown in FIG. 3A) to request the other DU(s) to provide detailed information for TRP(s) operated by the other DU(s). In response to each of the at least one CU-to-DU message that is received by a particular DU of the other DU(s), the particular DU transmits a TRP Information Response message (i.e., DU-to-CU message or F1AP message) including TRP information of a particular TRP to the CU 172.

After receiving all of the at least one DU-to-CU message from the DU 174 and/or the other DU(s), the CU 172 transmits, to the LMF 168, a BS-to-LMF message (e.g., TRP Information Response message) including the TRP information received from the DU 174 and/or the other DU(s). In some implementations, the TRP information for a particular TRP includes a positioning reference signal (PRS) configuration, a physical cell identity (PCI) and/or a cell global identifier (CGI). In some implementations, the DU-to-CU message includes a TRP ID of a particular TRP as well as the TRP information of the TRP, and the CU 172 includes the TRP ID and TRP information in the BS-to-LMF message.

After performing 306 the TRP Information Exchange procedure, the LMF 168 transmits 308, to the CU 172, a Measurement Preconfiguration Required message (i.e., LMF-to-BS message or NRPPa message) to request to configure measurement gap(s) for the UE 102 to measure PRS(s) transmitted by the TRP(s). In some implementations, the LMF 168 includes TRP PRS information item(s) (e.g., TRP-PRS-Information-List-Item IE(s)) in the Measurement Preconfiguration Required message of event 308. In some implementations, each of the TRP PRS information item(s) includes a PRS configuration, PCI, CGI, and/or TRP ID of a particular TRP of the TRP(s) operated by the DU 174. In some implementations, the LMF 168 determines the TRP PRS information item(s) in accordance with the at least one DU-to-CU message (e.g., the TRP ID(s) and TRP information) of the TRP Information Exchange procedure.

After or in response to receiving 308 the message, the CU 172 transmits 310 to the DU 174 a Measurement Preconfiguration Required message (i.e., CU-to-DU message or F1AP message), including the TRP PRS information item(s), to request to configure measurement gap(s) for the UE 102. In response, the DU 174 transmits 312, to the CU 172, a Measurement Preconfiguration Confirm message (i.e., DU-to-CU message or F1AP message) to confirm configuration of measurement gap(s) for the UE 102. After or in response to receiving 312 the Measurement Preconfiguration Confirm message, the DU 174 transmits 314, to the CU 172, a UE Context Modification Required message including gap configuration(s) for the UE 102. The gap configuration(s) configure measurement gap(s) for the UE 102 to measure PRS(s) transmitted by the TRP(s). In some implementations, the DU 174 generates the gap configuration(s) in accordance with the TRP PRS information item(s). In some implementations, the DU 174 generates the gap configuration(s) as RRC IE(s) (e.g., GapConfig IE(s) or GapConfig-r17 IE(s)). In some implementations, the DU 174 generates a measurement gap configuration (e.g., a MeasGapConfig IE) including the gap configuration(s) (e.g., GapConfig IE(s) or GapConfig-r17 IE(s)) and includes the measurement gap configuration in the UE Context Modification Required message. In some implementations, in each of the gap configuration(s), the DU 174 includes a preconfiguration indicator (e.g., a preConfigInd field) indicating that the gap configuration is a preconfigured gap configuration. In such cases, the DU 174 determines that the gap configuration, including the preconfiguration indicator, is initially deactiveated. For a gap configuration not including the preconfiguration indicator, the DU 174 determines that the gap configuration is initially activated. In some implementations, in each of the gap configuration(s), the DU 174 includes an indicator (e.g., a gapAssociationPRS field) indicating that the gap configuration is associated with PRS measurement. In some implementations, the DU 174 transmits 314 the UE Context Modification Required message before or after transmitting 312 the Measurement Preconfiguration Confirm message.

In some implementations, the DU 174 does not include the gap configuration(s) as interface IE(s) (e.g., F1AP IE(s)) in the Measurement Preconfiguration Confirm message. In some such implementations, the gap configuration(s) are transparent to the CU 172. In other implementations, the DU 174 includes at least some of the gap information as interface IE(s) (e.g., F1AP IE(s)) in the Measurement Preconfiguration Confirm message. In some such implementations, the gap configuration(s) are non-transparent to the CU 172.

In response to or after receiving 314 the UE Context Modification Required message, the CU 172 transmits 316 a UE Context Modification Confirm message to the DU 174. After receiving 312 the Measurement Preconfiguration Confirm message, receiving 314 the UE Context Modification Required message, or transmitting 316 the UE Context Modification Confirm message, the CU 172 transmits 318 a Measurement Preconfiguration Confirm message (i.e., a BS-to-LMF message or a NRPPa message) to the LMF 168 to confirm configuration of measurement gap(s) for the UE 102.

In some implementations, the DU 174 assigns a gap ID for each of the gap configuration(s). In some implementations, the DU 174 includes the gap ID in the corresponding gap configuration. In other implementations, the DU 174 includes the gap ID(s) in the measurement gap configuration along with the gap configuration(s). In some implementations, the DU 174 associates the gap ID(s) and/or corresponding gap configuration(s) with the TRP PRS information item(s). In some implementations, the DU 174 associates a particular gap ID and/or the corresponding gap configuration with a particular one of the TRP PRS information item(s). In other implementations, the DU 174 associates a particular gap ID and/or the corresponding gap configuration with some of the TRP PRS information item(s). In yet other implementations, the DU 174 associates particular gap IDs and/or the corresponding gap configurations with a particular one of the TRP PRS information item(s). In some implementations, the DU 174 creates a table to store the association(s) between the gap ID(s) and TRP PRS information item(s).

In other implementations, the CU 172 assigns a gap ID for each of the gap configuration(s). In some implementations, the CU 172 includes the gap ID in the corresponding gap configuration. In other implementations, the CU 172 includes the gap ID(s) in the measurement gap configuration along with the gap configuration(s). In some implementations, the CU 172 associates the gap ID(s) and/or corresponding gap configuration(s) with the TRP PRS information item(s). In some implementations, the CU 172 associates a particular gap ID and/or the corresponding gap configuration with a particular one of the TRP PRS information item(s). In other implementations, the CU 172 associates a particular gap ID and/or the corresponding gap configuration with some of the TRP PRS information item(s). In yet other implementations, the CU 172 associates particular gap IDs and/or the corresponding gap configurations with a particular one of the TRP PRS information item(s). In some implementations, the CU 172 creates a table to store the association(s) between the gap ID(s) and TRP PRS information item(s).

The events 310, 312, 314, and 316 are collectively referred to in FIG. 3A as a gap (pre) configuration procedure 392A.

After receiving the gap configuration(s) or measurement gap configuration, the CU 172 generates an RRC reconfiguration message (e.g., RRCReconfiguration message) including the gap configuration(s) or measurement gap configuration and transmits 320 a CU-to-DU message (e.g., DL RRC Message Transfer message), including the RRC reconfiguration message, to the DU 174. In turn, the DU 174 transmits 322 the RRC reconfiguration message to the UE 102. In response, the UE 102 transmits 324 an RRC reconfiguration complete message (e.g., RRCReconfigurationComplete message) to the DU 174, which in turn transmits 326 a DU-to-CU message (e.g., UL RRC Message Transfer message), including the RRC reconfiguration complete message, to the CU 172. To include the gap configuration(s) or measurement gap configuration in the RRC reconfiguration message, the CU 172, in some implementations, generates a measurement configuration (e.g., MeasConfig IE), including the measurement gap configuration, and includes the measurement configuration in the RRC reconfiguration message. In cases where the gap configuration includes the preconfiguration indicator, the UE 102 determines that the gap configuration including the indicator is initially deactivated.

The events 320, 322, 324, and 326 are collectively referred to in FIG. 3A as an RRC reconfiguration procedure 394. The events 308, 310, 312, 314, 316, 318, 320, 322, 324, and 326 are collectively referred to in FIG. 3A as a measurement gap configuration procedure 390A. In some implementations, additional measurement gap configuration procedure(s) are performed to configure additional gap configuration(s) for the UE 102, similar to the measurement gap configuration procedure 390A.

In some implementations, later in time, the LMF 168 transmits 328 a Measurement Activation message (i.e., LMF-to-BS message(s) or NRPPa message(s)) to the CU 172 to activate at least one of the gap configuration(s) that are deactivated. In some implementations, the Measurement Activation message of event 328 includes PRS measurement information (e.g., PRS-Measurements-Info-List-Item IE(s)), each including a reference point (e.g., pointA), a measurement PRS periodicity (e.g., measPRSPeriodicity), a measurement PRS offset (e.g., measPRSOffset), and/or a measurement PRS length (e.g., measurementPRSLength). In further implementations, in response to or after receiving 328 the Measurement Activation message, the CU 172 transmits 330 a Measurement Activation message (i.e., CU-to-DU message or F1AP message) to the DU 174 to activate at least one of the gap configuration(s) for the UE 102. In some implementations, the Measurement Activation message of event 330 includes PRS measurement information (e.g., PRS-Measurements-Info-List-Item IE(s)), each including a reference point (e.g., pointA), a measurement PRS periodicity (e.g., measPRSPeriodicity), a measurement PRS offset (e.g., measPRSOffset), and/or a measurement PRS length (e.g., measurementPRSLength). The PRS measurement information item(s) of event 328 can be similar to or the same as the PRS measurement information item(s) of event 330.

Depending on the implementation, in response to or after receiving 330 the Measurement Activation message, the DU 174 transmits 332 a measurement gap activation command to the UE 102 to activate at least one of the gap configuration(s). In some scenarios or implementations, if the CU 172 receives an RRC message (e.g., LocationMeasuementIndication message) requesting a measurement gap from the UE 102, the CU 172 transmits 330 the Measurement Activation message to the DU 174 in response to or after receiving the RRC message. In other scenarios or implementations, the CU 172 transmits 330 a Measurement Activation message to the DU 174 in response to or after receiving an LMF-to-BS message (e.g., Measurement Preconfiguration Required message 308) other than the Measurement Activation message of event 328. In some implementations, the measurement gap activation command is a DL MAC control element (e.g., Positioning Measurement Gap Activation/Deactivation Command MAC control element). In such implementations, the DU 174 generates a DL MAC PDU, including the DL MAC control element and a subheader for the DL MAC control element, and transmits 332 the DL MAC PDU to the UE 102. In some implementations, the subheader includes a logical channel ID specific for the measurement gap activation command.

Alternatively, the UE 102 transmits 329 a measurement gap activation request to the DU 174 to request to activate at least one of the gap configuration(s). In some implementations, in response to or after receiving 329 the measurement gap activation request, the DU 174 transmits 332 the measurement gap activation command to the UE 102. In some implementations, the measurement gap activation request is a UL MAC control element (e.g., Positioning Measurement Gap Activation/Deactivation Request MAC control element). In such implementations, the UE 102 generates a UL MAC PDU, including the UL MAC control element and a subheader for the UL MAC control element, and transmits 329 the UL MAC PDU to the DU 174. In some implementations, the subheader includes a logical channel ID specific for the UL MAC control element. In the measurement gap activation request, the UE 102, in some implementations, includes at least one gap ID indicating the gap configuration(s) that the UE 102 requests to activate. In other implementations, the UE 102 does not include a gap ID in the measurement gap activation request in order to request activating all of the gap configuration(s). In yet other implementations, the UE 102 includes a specific field with a specific value in the measurement gap activation request in order to request activating all of the gap configuration(s) instead of all of the gap ID(s).

In some implementations, the DU 174 includes at least one gap ID indicating the gap configuration(s) to be activated in the measurement gap activation command. In some implementations, the DU 174 determines (e.g., identifies, selects or derives) the at least one gap ID based on the TRP PRS information item(s) received at event 330 and/or the association(s). In some implementations, the DU 174 performs a look up of the table to determine the at least one one gap ID based on the TRP PRS information item(s) received at event 330. In some cases, such as receiving 329 the measurement gap activation request, the DU 174 sets the at least one gap ID in the measurement gap activation command to value(s) of the gap ID(s) in the measurement gap activation request.

In some implementations, the DU 174 does not include a gap ID in the measurement gap activation command in order to activate all of the gap configuration(s). In further implementations, the UE 102 includes a specific field with a specific value in the measurement gap activation request to request activation of all of the gap configuration(s) instead of including all of the gap ID(s).

In some implementations, the DU 174 transmits 334, to the CU 172, a DU-to-CU message including a measurement gap status indicating the status (e.g., activated or deactivated) of the gap configuration(s) after transmitting the measurement gap activation command to the UE 102 or receiving the measurement gap activation request from the UE 102. Thus, the CU 172 determines that the UE 102 activates the at least one of the gap configuration(s) and/or starts performing measurements on PRS(s) transmitted by the TRP(s) from the measurement gap status. In some implementations, the CU 172 transmits 336 a BS-to-LMF message, including the measurement gap status, to the LMF 168. Thus, the LMF 168 determines that the UE 102 activates the gap configuration(s) and/or starts performing measurements on PRS(s) transmitted by the TRP(s) from the measurement gap status.

The events 328, 330, 329, 332, 334 and 336 are collectively referred to in FIG. 3A as a measurement gap activation procedure 396. In some implementations, additional measurement gap activation procedure(s) are performed to activate additional gap configuration(s) configured in the procedure 390A or additional measurement gap configuration procedure(s), similar to the measurement gap activation procedure 396.

In response to or after receiving 332 the measurement gap activation command, the UE 102 activates 338 the at least one gap configuration identified by the at least one gap ID in the measurement gap activation command. After activating the gap configuration(s), the UE 102 performs 338 measurements on PRS(s) transmitted by the TRP(s), using gap(s) in the activated gap configuration(s). In some implementations, the UE 102 obtains measurement results from the measurements and transmits 340 the measurement results to the LMF 168 via the base station 104 (i.e., the DU 174 and CU 172). In some implementations, the UE 102 generates LPP message(s) (e.g., Provide LocationInformation message(s)), including the measurement results, and transmits 340 the LPP message(s) to the LMF 168 via the base station 104.

In some implementations, the CU configuration includes configuration parameters in a RadioBearerConfig information element (IE) and/or MeasConfig IE (e.g., as defined in 3GPP specification 38.331 v16.7.0 or later). In some implementations, the CU configuration is or includes a RadioBearerConfig IE and/or a MeasConfig IE, and the second CU configuration is or includes a RadioBearerConfig IE and/or MeasConfig IE. In some implementations, the DU configuration includes configuration parameters related to operations of RRC, RLC, MAC, and/or PHY protocol layers (e.g., RLC 206B, MAC 204B, and/or PHY 202B) that the UE 102 and DU 174 use to communicate with one another while the UE 102 operates in the connected state. In some implementations, the DU configuration includes configuration parameters in a CellGroupConfig IE (e.g., as defined in 3GPP specification 38.331 v16.7.0). In some implementations, the DU configuration is a CellGroupConfig IE.

In some implementations, i the DU 174 has not activated a gap configuration for the UE 102 (i.e., the DU 174 has not transmitted, to the UE 102, a measurement gap activation command to activate the gap configuration), the DU 174 schedules a DL transmission or a UL transmission for the UE 102 in a slot within a gap configured in the gap configuration. As the UE 102 has not activated the gap configuration (i.e., the UE 102 has not received from the DU 174 a measurement gap activation command to activate the gap configuration), the UE 102 monitors a PDCCH in a slot within a gap configured in the gap configuration. For example, the DU 174 generates DL control information (DCI) for a DL transmission, generates a CRC of the DCI, scrambles the CRC with the C-RNTI, and transmits the DCI and the scrambled CRC on a PDCCH in a slot within a measurement gap configured in the gap configuration. The UE 102 receives the DCI and scrambled CRC on the PDCCH in the slot.

If the DU 174 has activated a gap configuration for the UE 102 (i.e., the DU 174 has transmitted, to the UE 102, a measurement gap activation command to activate the gap configuration), the DU 174 refrains from scheduling a DL transmission or a UL transmission for the UE 102 in a slot within a gap configured in the gap configuration. As the UE 102 has activated the gap configuration (i.e., the UE 102 has received, from the DU 174, a measurement gap activation command to activate the gap configuration), the UE 102 refrains from monitoring a PDCCH in a slot within a gap configured in the gap configuration.

Referring next to FIG. 3B, a scenario 300B is generally similar to the scenario 300A, except that the CU 172 transmits 315 a UE Context Modification Request message to the DU 174 to request gap configuration(s), and the DU 174 transmits 317 a UE Context Modification Response message including the gap configuration(s) in response. In the scenario 300B, the DU 174 refrains from transmitting a UE Context Modification Required message including gap configuration(s) to the CU 172. In some implementations, the CU 172 transmits 315 the UE Context Modification Request message to the DU 174 after transmitting 310 the Measurement Preconfiguration Required message.

In some implementations, the CU 172 includes an indication that indicates to the DU 174 to generate gap configuration(s) for positioning measurement in the UE Context Modification Request message. In response to the indication, the DU 174 generates the gap configuration(s) in accordance with the TRP PRS information item(s) and includes the gap configuration(s) in the UE Context Modification Response message. In other implementations, the UE Context Modification Request message does not include the indication. In some such implementations, the CU 172 transmits the UE Context Modification Request message immediately after transmitting 310 the Measurement Preconfiguration Required message, so that the DU 174 can correlate the UE Context Modification Request message with the Measurement Preconfiguration Required message.

In some implementations, the DU 174 generates a measurement gap configuration IE (e.g., a MeasGapConfig 1E) including the gap configuration(s) (e.g., GapConfig IE(s) or GapConfig-r17 IE(s)) and includes the measurement gap configuration in the UE Context Modification Response message.

The events 310, 312, 315, and 317 are collectively referred to in FIG. 3B as a gap (pre) configuration procedure 392B. The events 308, 310, 312, 315, 317, 318, 320, 322, 324, and 326 are collectively referred to in FIG. 3B as a measurement gap configuration procedure 390B.

Referring next to FIG. 3C, a scenario 300C is generally similar to the scenarios 300A and 300B, except that the DU 174 transmits 313 a Measurement Preconfiguration Confirm message including the gap configuration(s) in response to the Measurement Preconfiguration Required message of event 310. In the scenario 300C, the DU 174 refrains from transmitting a UE Context Modification Required message including the gap configuration(s) to the CU 172.

In some implementations, the DU 174 generates a measurement gap configuration IE (e.g., a MeasGapConfig 1E) including the gap configuration(s) (e.g., GapConfig IE(s) or GapConfig-r17 IE(s)) and includes the measurement gap configuration in the Measurement Preconfiguration Confirm message of event 313.

The events 310 and 313 are collectively referred to in FIG. 3C as a gap (pre) configuration procedure 392C. The events 308, 310, 313, 318, and 394 are collectively referred to in FIG. 3C as a measurement gap configuration procedure 390C.

Referring next to FIG. 3D, a scenario 300D is generally similar to the scenarios 300A-C. The differences among the scenarios 300D and scenarios 300A-C are discussed below.

In the scenario 300D, the events 304, 306, 390A/390B/390C, 396, 338, and 340 are collectively referred to in FIG. 3D as a positioning measurement procedure 388. In some implementations, after the positioning measurement procedure 388, the LMF 168 transmits 342 to the CU 172 an LMF-to-BS message causing the CU 172 to deactivate at least one of the activated gap configuration(s). In some implementations, the LMF-to-BS message is a new NRPPa message (e.g., a Measurement Deactivation message). In other implementations, the LMF-to-BS message is an existing NRPPa message (e.g., a Measurement Abort message). In response to or after receiving the LMF-to-BS message, the CU 172 transmits 344 to the DU 174 a CU-to-DU message causing the DU 174 to deactivate at least one of the activated gap configuration(s). In response to or after receiving the CU-to-DU message, the DU 174 transmits 348 a measurement gap deactivation command to the UE 102 to deactivate at least one of the activated gap configuration(s). In some implementations, the measurement gap deactivation command is a DL MAC control element (e.g., Positioning Measurement Gap Activation/Deactivation Command MAC control element). In such implementations, the DU 174 generates a DL MAC PDU including the DL MAC control element and a subheader for the DL MAC control element and transmits 348 the DL MAC PDU to the UE 102. In some implementations, the subheader includes a logical channel ID specific for the measurement gap deactivation command. In other implementations, the subheader includes the logical channel ID, which is the same as the subheader for the measurement gap activation command. In some such implementations, the measurement gap activation command and the measurement gap deactivation command use the same DL MAC control element format. In some implementations, the format includes a field indicating the number of gap configurations to be activated or deactivated. In some implementations, the format includes a single field with a first value or a second value indicating that the DL MAC control element format is a measurement gap activation command or a measurement gap deactivation command. The first value indicates that the DL MAC control element format is a measurement gap activation command. The second value indicates that the DL MAC control element format is a measurement gap deactivation command. In other implementations, the format includes a field for each gap configuration included in the DL MAC control element format. The first value of the field indicates “activation” for the gap configuration, and the second value indicates “deactivation” for the gap configuration. In some such implementations, the DL MAC control element format activates some gap configuration(s) and deactivates other gap configuration(s).

In some implementations, CU 172 does not include, in the CU-to-DU message of event 344, information that the DU 174 can use to derive which gap configuration(s) to deactivate. In such implementations, the DU 174 deactivates all of the activated gap configuration(s) for the UE 102 in response to the CU-to-DU message of event 344. In other implementations, the CU 172 includes, in the CU-to-DU message of event 344, information (e.g., PRS measurement information item(s)) that the DU 174 can use to derive which gap configuration(s) to deactivate.

In some implementations, the CU-to-DU message of event 344 is a new F1AP message (e.g., a Measurement Deactivation message). In other implementations, the CU-to-DU message of event 344 is an existing F1AP message (e.g., a Measurement Preconfiguration Abort message). In yet other implementations, the CU-to-DU message of event 344 is a Measurement Activation message including a deactivation indication and/or not including PRS measurement information item(s) (e.g., PRS-Measurements-Info-List-Item IE(s)). In such implementations, the Measurement Activation message is treated as a Measurement Deactivation message. In yet other implementations, the CU-to-DU message of event 344 is a Measurement Activation message including PRS measurement information item(s) (e.g., PRS-Measurements-Info-List-Item IE(s)) and a deactivation indication for each of the PRS measurement information item(s).

Alternatively, the UE 102 transmits 346 a meaurement gap deactivation request to the DU 174 to request to deactivate at least one of the activated gap configuration(s). Depending on the implementation, in response to or after receiving 346 the measurement gap deactivation request, the DU 174 transmits 348 the measurement gap deactivation command to the UE 102. In some implementations, the measurement gap deactivation request is a UL MAC control element (e.g., Positioning Measurement Gap Activation/Deactivation Request MAC control element). In such implementations, the UE 102 generates a UL MAC PDU, including the UL MAC control element and a subheader for the UL MAC control element, and transmits 346 the UL MAC PDU to the DU 174. In some implementations, in the measurement gap deactivation request, the UE 102 includes gap ID(s) indicating the activated gap configuration(s) that the UE 102 requests to deactivate. In some implementations, the subheader includes a logical channel ID specific for the measurement gap deactivation request. In other implementations, the subheader includes the logical channel ID (e.g., which is the same as the subheader for the measurement gap activation request). In some such implementations, the measurement gap activation request and the measurement gap deactivation request use the same UL MAC control element format. In some implementations, the format includes a field indicating the number of gap configurations to be requested for activation or deactivation. In some implementations, the format includes a single field with a first value or a second value indicating whether the UL MAC control element format is a measurement gap activation request or a measurement gap deactivation request. The first value indicates that the UL MAC control element format is a measurement gap activation request. The second value indicates that the UL MAC control element format is a measurement gap deactivation request. In other implementations, the format includes a field for each gap configuration included in the UL MAC control element format. The first value of the field indicates “activation request” for the gap configuration, and the second value indicates “deactivation request” for the gap configuration. In some such implementations, the DL MAC control element format requests activation of some gap configuration(s) and deactivation of other gap configuration(s).

In some implementations, the DU 174 includes gap ID(s) indicating the gap configuration(s) to be deactivated in the measurement gap deactivation command. In some implementations, the DU 174 determines gap ID(s) based on the PRS measurement information item(s) included in the CU-to-DU message of event 344, if included. In some implementations, the DU 174 performs a look up of the table (e.g., as described for FIG. 3A) to determine the gap ID(s) based on the PRS measurement information item(s). In some cases, such as when receiving 346 the measurement gap deactivation request, the DU 174 sets the gap ID(s) in the measurement gap deactivation command to value(s) of the gap ID(s) in the measurement gap deactivation request.

In some implementations, the DU 174 transmits 350, to the CU 172, a DU-to-CU message, including measurement gap status indicating that the gap configuration(s) for the UE 102 are deactivated, after or in response to transmitting 348 the measurement gap deactivation command to the UE 102. Thus, the CU 172 determines that the UE 102 deactivates the gap configuration(s) and/or stops performing measurements on PRS(s) transmitted by the TRP(s) from the measurement gap status. In some implementations, the DU-to-CU message of event 350 is an existing F1AP message (e.g., as defined in 3GPP specification 38.473). In other implementations, the DU-to-CU message is a new F1AP message (e.g., a Measurement Status message or Measurement Gap Status message). In some cases where some gap configuration(s) for the UE 102 are still activated, the measurement gap status includes status (i.e., activated) of the gap configuration(s).

In some implementations, the CU 172 transmits 352 a BS-to-LMF message including the measurement gap status to the LMF 168. Thus, the LMF 168 determines that the UE 102 deactivates the gap configuration(s) and/or stops performing measurements on PRS(s) transmitted by the TRP(s) from the measurement gap status. In some implementations, the BS-to-LMF message of event 352 is an existing NRPPa message (e.g., as defined in 3GPP specification 38.455). In other implementations, the BS-to-LMF message is a new NRPPa message (e.g., a Measurement Status message or Measurement Gap Status message).

The events 342, 344, 346, 348, 350 and 3752 are collectively referred to in FIG. 3D as a measurement gap deactivation procedure 398.

Later in time, depending on the implementation, the LMF 168, CU 172, and/or DU 174 perform 395 a measurement gap activation procedure with the UE 102 to activate the deactivated gap configuration(s). In some implementations, in response to the measurement gap activation procedure 395, the UE 102 activates 339 the gap configuration(s) identified by the gap ID(s) in a measurement gap activation command in the procedure 395. After activating the gap configuration(s), the UE 102 performs 339 measurements on PRS(s) transmitted by the TRP(s), using gap(s) in the activated gap configuration(s). In some implementations, the UE 102 obtains measurement results from the measurements and transmits 341 the measurement results to the LMF 168 via the base station 104 (i.e., the DU 174 and CU 172). In some implementations, the UE 102 generates LPP message(s) (e.g., ProvideLocationInformation message(s)), including the measurement results, and transmits 341 the LPP message(s) to the LMF 168 via the base station 104.

Referring next to FIG. 3E, a scenario 300E is generally similar to the scenarios 300A-D. The differences among the scenarios 300E and scenarios 300A-D are discussed below.

In some implementations, after the positioning measurement procedure 388, the LMF 168 transmits 343, to the CU 172, an LMF-to-BS message causing the CU 172 to release the gap configuration(s). In some implementations, the LMF-to-BS message is an existing NRPPa message (e.g., as defined in 3GPP specification 38.455). For example, the LMF-to-BS message is a Measurement Preconfiguration Required message, a Measurement Abort message, or an Error Indication message. In other implementations, the LMF-to-BS message is a new NRPPa message. For example, the LMF-to-BS message is a Measurement Deactivation message, Measurement Preconfiguration Release Required message, or Measurement Preconfiguration Release Request message.

In response to or after receiving 343 the LMF-to-BS message, the CU 172 transmits 345, to the DU 174, a CU-to-DU message causing the DU 174 to release at least one of the gap configuration(s). In response to or after receiving 345 the CU-to-DU message, the DU 174 releases the at least one of the gap configuration(s) for the UE 102. In some implementations, the CU-to-DU message is an existing F1AP message (e.g., as defined in 3GPP specification 38.473). For example, the CU-to-DU message is a Positioning Measurement Abort message, a Measurement Preconfiguration Required message, or a UE Context Modification Request message. In other implementations, the CU-to-DU message is a new F1AP message (e.g., a Measurement Deactivation message, a Measurement Preconfiguration Release Required message, or a Measurement Preconfiguration Release Request message). Depending on the implementation, the DU 174 transmits 347 a DU-to-CU message to the CU 172 in response to the CU-to-DU message. In some implementations, the DU-to-CU message of event 347 is an existing F1AP message (e.g., a Measurement Preconfiguration Confirm message or a UE Context Modification Response message).

In response to or after receiving the LMF-to-BS message, the CU 172 generates an RRC reconfiguration message (e.g., RRCReconfiguration message) releasing the gap configuration(s) and transmits 321 a CU-to-DU message (e.g., DL RRC Message Transfer message), including the RRC reconfiguration message, to the DU 174. In turn, the DU 174 transmits 323 the RRC reconfiguration message to the UE 102. In response to or after receiving 323 the RRC reconfiguration message, the UE 102 releases the gap configuration(s).

In some implementations, the RRC reconfiguration message includes gap release information including the gap ID(s) of the at least one of the gap configuration(s) to release the gap configuration(s). For example, the gap release information is a gap release list IE. In such implementations, the UE 102 identifies the at least one of the gap configuration(s) in accordance with the gap ID(s) and releases the identified gap configuration(s) in response to the RRC reconfiguration message or the gap release information. In some implementations, the CU 172 generates the gap release information and includes the gap release information in the CU-to-DU message of event 345. In such implementations, the DU 174 identifies the gap configuration(s) in accordance with the gap ID(s) and releases the identified gap configuration(s) in response to the CU-to-DU message or the gap release information.

In response to the RRC reconfiguration message, the UE 102 transmits 325 an RRC reconfiguration complete message (e.g., RRCReconfigurationComplete message) to the DU 174, which in turn transmits 327 a DU-to-CU message (e.g., UL RRC Message Transfer message), including the RRC reconfiguration complete message, to the CU 172. In some implementations, after receiving 327 the DU-to-CU message of event 327, the CU 172 transmits 353 a BS-to-LMF message to the LMF 168 in response to the LMF-to-BS message of event 343. Alternatively, the CU 172 transmits 353 the BS-to-LMF message before receiving the DU-to-CU message of event 327.

In some implementations, the CU 172 autonomously determines to release the at least one of the gap configuration(s) without receiving an LMF-to-BS message like event 343. In such implementations, the CU 172 transmits 345 the CU-to-DU message and/or 321 the RRC reconfiguration message to the DU 174 in response to the determination.

In some implementations, later in time, the LMF 168, CU 172, and/or DU 174 performs 389 a positioning measurement procedure with the UE 102, similar to procedure 388.

In some implementations, the LMF 168, CU 172, and/or DU 174 perform 398 a measurement gap deactivation procedure after performing 388 the positioning measurement procedure and before receiving 343 the LMF-to-BS message or transmitting 345 the CU-to-DU message.

Referring next to FIG. 3F, a scenario 300F is generally similar to the scenarios 300A-E. The differences among the scenarios 300F and scenarios 300A-E are discussed below.

In the scenario 300F, the DU 174 transmits 354 a UE Context Modification Required message, including the gap release information indicating to release the gap configuration(s), after or in response to receiving 345 the CU-to-DU message. In response, the CU 172 transmits 356 a UE Context Modification Confirm message to the DU 174. In some implementations, the CU 172 includes the gap release information received, from the DU 174, in the RRC reconfiguration message. In some such implementations, the CU 172 does not include the gap release information in the CU-to-DU message of event 345.

Next, several example methods that can be implemented in a DU of a BS or a CU of the BS are discussed with reference to FIGS. 4A-8. Each of these methods can be implemented using processing hardware such as one or more processors to execute instructions stored on a non-transitory computer-readable medium such as computer memory.

Referring first to FIG. 4A, a method 400A is a method for configuring a measurement gap for a UE (e.g., the UE 102) and is implemented in a DU (e.g., the DU 174).

The method 400A begins at block 402, where the DU communicates with a UE and a CU (e.g., the CU 172). At block 404, the DU receives, from the CU, a first CU-to-DU message requesting configuration of a measurement gap for the UE (e.g., event 310). At block 406, the DU transmits, to the CU, a first DU-to-CU message in response to the first CU-to-DU message (e.g., event 312). In some implementations, the DU transmits, to the CU, the first DU-to-CU message to confirm a successful configuration of measurement gap(s). At block 408, the DU transmits, to the CU, a second DU-to-CU message, including gap configuration(s) 1, . . . , M for the UE, in response to the first CU-to-DU message (e.g., event 314), where M is an integer and larger than zero. At block 410, the DU receives, from the CU, a second CU-to-DU message in response to the second DU-to-CU message (e.g., event 316). At block 412, the DU transmits a measurement gap activation command to the UE to activate at least one of the one or more of gap configurations (e.g., event 332).

In some implementations, the first CU-to-DU message includes TRP PRS information item(s) 1, . . . , N, where Nis an integer and larger than zero. In some implementations, the first CU-to-DU message does not include measurement object information (e.g., MeasObjectToAddModList IE or MeasObjectToAddMod IE(s)). In some implementations, the DU generates a measurement gap configuration (e.g., a MeasGapConfig IE) including the gap configuration(s) 1, . . . , M (e.g., GapConfig IE(s) or GapConfig-r17 IE(s) 1, . . . , M) and includes the measurement gap configuration in the second DU-to-CU message. In some implementations, the DU generates the gap configuration(s) for positioning measurement (e.g., the UE uses gap(s) in the gap configuration(s) 1, . . . , M to measure PRS(s)).

In some implementations, the DU assigns gap ID(s) 1, . . . , M for the gap configuration(s) 1, . . . , M, respectively. In some implementations, the DU includes the gap ID(s) 1, . . . , M in the gap configuration(s) 1, . . . , M, respectively. In other implementations, the DU includes the gap ID(s) 1, . . . , M in the measurement gap configuration along with the gap configuration(s) 1, . . . , M. In some implementations, the DU associates the gap ID(s) 1, . . . , M with the TRP PRS information item(s) 1, . . . , N. In some implementations, the DU associates a particular one of the gap ID(s) with a particular one of the TRP PRS information item(s). In other implementations, the DU 174 associates a particular one of the gap ID(s) with some of the TRP PRS information item(s). In some implementations, the DU creates a table to store the association(s) between the gap ID(s) and TRP PRS information item(s).

In the measurement gap activation command, the DU includes at least of the gap ID(s) 1, . . . , M. Each of the at least one gap ID identifies a particular one of the at least one gap configuration of the gap configuration(s) 1, . . . , M.

FIG. 4B is a flow diagram of an example method 400B similar to the method 400A, except that method 400B includes blocks 409 and 411 instead of blocks 408 and 410. At block 409, the DU receives, from the CU, a second CU-to-DU message requesting configuring a measurement gap for the UE (e.g., event 315). At block 411, the DU transmits, to the CU, a second DU-to-CU message, including gap configuration(s) 1, . . . , M for the UE, in response to the second CU-to-DU message (e.g., event 317).

FIG. 4C is a flow diagram of an example method 400C similar to the method 400A, except that method 400C includes block 407 instead of blocks 406, 408, and 410. At block 407, the DU transmits, to the CU, a first DU-to-CU message, including gap configuration(s) 1, . . . , M for the UE, to confirm a successful configuration of measurement gap in response to the first CU-to-DU message (e.g., event 313).

In some implementations, the DU generates a measurement gap configuration (e.g., a MeasGapConfig 1E) including the gap configurations(s) 1, . . . , M (e.g., GapConfig IE(s) or GapConfig-r17 IE(s) 1, . . . , M) and includes the measurement gap configuration in the first DU-to-CU message.

Examples and implementations described in the previous figures (e.g., FIGS. 3A-3F) can apply to FIGS. 4A-4C.

Referring new to FIG. 5A, a method 500A is a method for configuring a measurement gap for a UE (e.g., the UE 102) and is implemented in a CU (e.g., the CU 172).

The method 500A begins at block 502, where the CU communicates with a UE and a DU (e.g., the DU 174). At block 504, the CU transmits, to the DU, a first CU-to-DU message requesting configuration of a measurement gap for the UE (e.g., event 310). At block 506, the CU receives, from the DU, a first DU-to-CU message in response to the first CU-to-DU message (e.g., event 312). In some implementations, the first DU-to-CU message confirms a successful configuration of measurement gap(s). At block 508, the CU receives, from the DU, a second DU-to-CU message, including gap configuration(s) 1, . . . , M, after transmitting the first CU-to-DU message (e.g., event 314), where M is an integer and larger than zero. At block 510, the CU transmits, to the DU, a second CU-to-DU message in response to the second DU-to-CU message (e.g., event 316). At block 512, the CU transmits a message including the gap configuration(s) 1, . . . , M to the UE via the DU (e.g., events 320, 322). At block 514, the CU transmits a third CU-to-DU message to the DU to command the DU to activate at least one of the gap configuration(s) 1, . . . , M (e.g., event 330). At block 516, the CU receives one or more measurement results from the UE via the DU (e.g., event 340).

In some implementations, the first CU-to-DU message includes TRP PRS information item(s) 1, . . . , N, where Nis an integer and larger than zero. In some implementations, the first CU-to-DU message does not include measurement object information (e.g., MeasObjectToAddModList IE or MeasObjectToAddMod IE(s)). In some implementations, the second DU-to-CU message includes a measurement gap configuration (e.g., a MeasGapConfig 1E) including the gap configuration(s) 1, . . . , M (e.g., GapConfig IE(s) or GapConfig-r17 IE(s) 1, . . . , M).

FIG. 5B is a flow diagram of an example method 500B similar to the method 500A, except that method 500B includes blocks 509 and 511 instead of blocks 508 and 510. At block 509, the CU transmits, to the DU, a second CU-to-DU message after transmitting the first CU-to-DU message (e.g., event 315). At block 511, the CU receives, from the DU, a second DU-to-CU message including gap configuration(s) 1, . . . , M in response to the second CU-to-DU message (e.g., event 317).

FIG. 5C is a flow diagram of an example method 500C similar to the method 500A, except that method 500C includes block 507 instead of blocks 506, 508, and 510. At block 507, the CU receives, from the DU, a first DU-to-CU message, including gap configuration(s) 1, . . . , M for the UE, in response to the first CU-to-DU message (e.g., event 313). In some implementations, the first DU-to-CU message confirms a successful configuration of measurement gap(s).

Examples and implementations described in the previous figures (e.g., FIGS. 3A-4C) can apply to FIGS. 5A-5C.

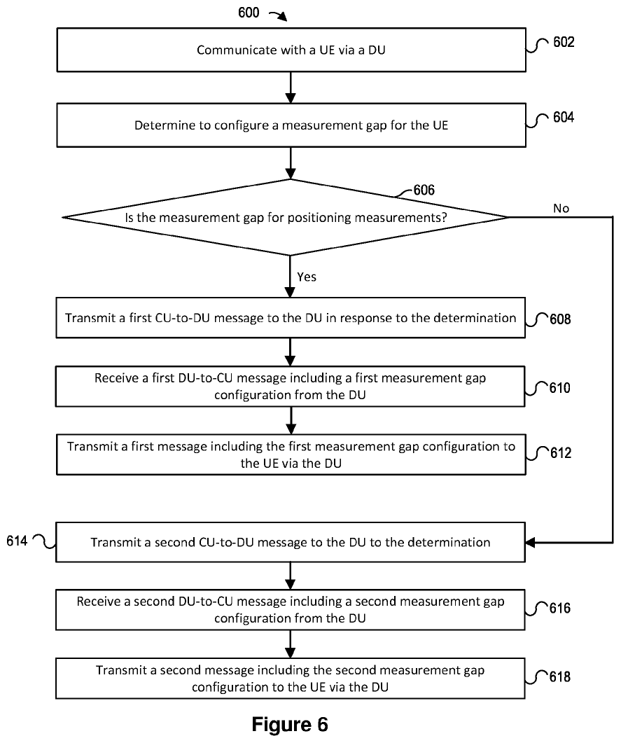

Referring next to FIG. 6, a method 600 is a method for configuring a measurement gap for a UE (e.g., the UE 102) and is implemented in a CU (e.g., the CU 172).

The method 600 begins at block 602, where the CU communicates with a UE via a DU (e.g., the DU 174). At block 604, the CU determines to configure a measurement gap for the UE. At block 606, the CU determines whether the measurement gap is for positioning measurements. If the measurement gap is for positioning measurements, the flow proceeds to block 608. At block 608, the CU transmits a first CU-to-DU message to the DU in response to the determination (e.g., event 310). At block 610, the CU receives a first DU-to-CU message including a first measurement gap configuration (e.g., MeasGapConfig 1E) from the DU (e.g., events 314, 317, 313). At block 612, the CU transmits a first message including the first measurement gap configuration to the UE via the DU (e.g., events 320, 322). Otherwise, if the measurement gap is not for positioning measurements, the flow proceeds to block 614. At block 614, the CU transmits a second CU-to-DU message to the DU for the determination. At block 616, the CU receives a second DU-to-CU message including a second measurement gap configuration (e.g., MeasGapConfig 1E) from the DU. At block 618, the CU transmits a second message including the second measurement gap configuration to the UE via the DU.

In some implementations, the first CU-to-DU message includes TRP PRS information item(s) and the second CU-to-DU message does not include TRP PRS information item(s). In some implementations, the second CU-to-DU message includes measurement object information (e.g., MeasObjectToAddModList IE or MeasObjectToAddMod IE(s)) and the first CU-to-DU message does not include measurement object information.

In some implementations, the second CU-to-DU message and the second DU-to-CU message are a UE Context Modification Request message and a UE Context Modification Response message. In other implementations, the second CU-to-DU message and the second DU-to-CU message are a UE Context Modification Request message and a UE Context Modification Required message. In such implementations, the CU receives a UE Context Modification Response message from the DU in response to the UE Context Modification Request message, and the CU transmits a UE Context Modification Confirm message to the DU in response to the UE Context Modification Required message.

In some implementations, the second message is an RRC reconfiguration message. In some such implementations, the CU receives an RRC reconfiguration complete message from the UE via the DU, in response to the RRC reconfiguration message.

Examples and implementations described in the previous figures (e.g., FIGS. 3A-5C) can apply to FIG. 6.

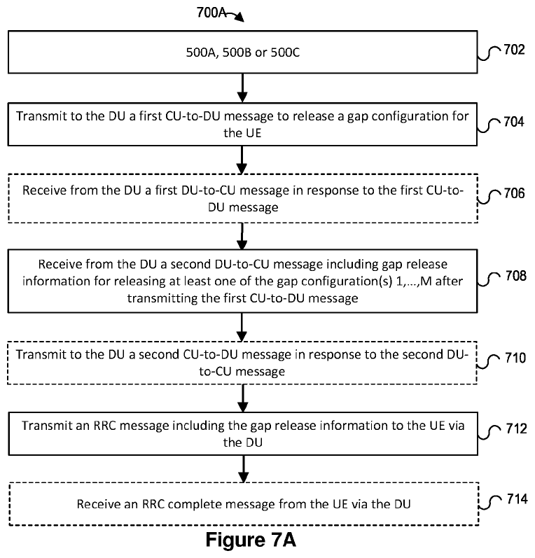

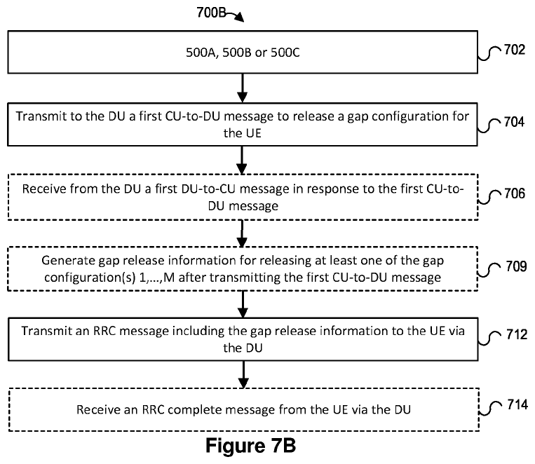

Referring next to FIG. 7A, a method 700A is a method for configuring a measurement gap for a UE (e.g., the UE 102) and is implemented in a CU (e.g., the CU 172).

The method 700A begins at block 702, where the flow performs at least one of the methods 500A, 500B, or 500C. At block 704, the CU transmits, to the DU, a first CU-to-DU message to release a gap configuration for the UE (e.g., event 345). At block 706, the CU receives, from the DU, a first DU-to-CU message in response to the first CU-to-DU message (e.g., event 347). At block 708, the CU receives, from the DU, a second DU-to-CU message, including gap release information for releasing at least one of the gap configuration(s) 1, . . . , M, after transmitting the first CU-to-DU message (e.g., event 354). At block 710, the CU transmits, to the DU, a second CU-to-DU message in response to the second DU-to-CU message (e.g., event 356). At block 712, the CU transmits an RRC message including the gap release information to the UE via the DU (e.g., events 321, 323). At block 714, the CU receives an RRC complete message from the UE via the DU (e.g., events 325, 327).

In some implementations, the gap release information includes gap ID(s) identifying at least one gap configuration. Each of the gap ID(s) identifies a particular one of the gap configuration(s). In some implementations, the DU identifies the released gap configuration(s) in accordance with the first CU-to-DU message. In some implementations, the first CU-to-DU message does not include measurement object information (e.g., MeasObjectToAddModList IE or MeasObjectToAddMod IE(s)).

In some implementations, the CU at block 702 (e.g., method 500A, 500B or 500C) receives the gap ID(s) from the DU. In some implementations, the CU includes gap ID(s) for the at least one gap configuration in the first CU-to-DU message. Thus, the DU can identify the at least one gap configuration in accordance with the gap ID(s) and releases the at least one gap configuration accordingly. Alternatively, the CU does not include a gap ID in the first CU-to-DU message.

In some implementations, the CU at block 702 transmits first TRP PRS information item(s) to the DU. In some implementations, the CU includes zero TRP PRS information item(s) in the first CU-to-DU message (i.e., the CU does not include TRP PRS information item(s) in the first CU-to-DU message). In some implementations, the CU includes zero TRP PRS information item(s) to indicate or request to release all of the gap configuration(s). When, after, or in response to receiving zero TRP PRS information item(s) in the first CU-to-DU message, the DU releases all the gap configuration(s). When, after, or in response to receiving zero TRP PRS information item(s) in the first CU-to-DU message, the DU generates the gap release information including gap ID(s) for all of the gap configuration(s), in some implementations.

In other implementations, the CU transmits, to the DU, the first CU-to-DU message to indicate that positioning measurement is not needed or configured. In such implementations, when, after, or in response to receiving the first CU-to-DU message, the DU releases all the gap configuration(s). In some implementations, when, after, or in response to receiving the first CU-to-DU message, the DU generates the gap release information including gap ID(s) for all of the gap configuration(s).

In other implementations, the CU includes second TRP PRS information item(s) of the first TRP PRS information item(s) in the first CU-to-DU message. In some such implementations, the DU identifies the released gap configuration(s) based on the second TRP PRS information item(s) and the first TRP PRS information item(s). For example, the released gap configuration(s) are associated with TRP PRS information item(s) not included in the second TRP PRS information item(s). In some implementations, the DU generates the gap release information, including gap ID(s) for the released gap configuration(s), after identifying the released gap configuration(s).

In some implementations, the CU transmits the first CU-to-DU message to the DU in response to receiving an LMF-to-BS message. For example, the LMF-to-BS message is or is part of event 343 of FIG. 3E or 3F. In other implementations, the CU transmits the first CU-to-DU message to the DU in response to receiving a third DU-to-CU message from the DU. For example, the third DU-to-CU message is or is part of event 350 of FIG. 3D. In another example, the third DU-to-CU message is a Positioning Measurement Failure Indication message.

FIG. 7B is a flow diagram of an example method 700B similar to the method 700A, except that method 700B includes block 709 instead of blocks 708 and 710. At block 709, the CU generates gap release information for releasing the at least one measurement gap configuration after transmitting the first CU-to-DU message.

Examples and implementations described in the previous figures (e.g., FIGS. 3A-6) can apply to FIGS. 7A and 7B.

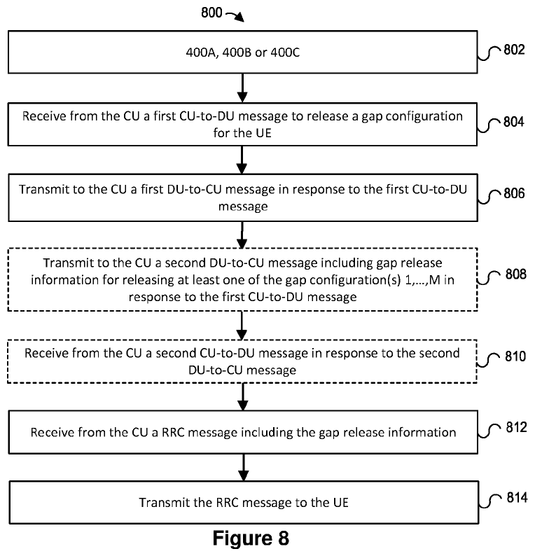

Referring next to FIG. 8, a method 800 is a method for configuring a measurement gap for a UE (e.g., the UE 102) and is implemented in a DU (e.g., the DU 174).

The method 800 begins at block 802, where the flow performs at least one of 400A, 400B, or 400C. At block 804, the DU receives, from the DU, a first CU-to-DU message to release a gap configuration for the UE (e.g., event 345). At block 806, the DU transmits, to the DU, a first DU-to-CU message in response to the first CU-to-DU message (e.g., event 347). At block 808, the DU transmits, to the CU, a second DU-to-CU message, including gap release information for releasing at least one of the gap configuration(s) 1, . . . , M, in response to the first CU-to-DU message (e.g., event 354). At block 810, the DU receives, from the CU, a second CU-to-DU message in response to the second DU-to-CU message (e.g., event 356). At block 812, the DU receives, from the CU, an RRC message including the gap release indication (e.g., event 321). At block 814, the DU transmits the RRC message to the UE (e.g., event 323).

Examples and implementations described in the previous figures (e.g., FIGS. 3A-7B) can apply to FIG. 8.

The following description may be applied to the description above.

Generally speaking, description for one of the above figures can apply to another of the above figures. An event or block described above can be optional or omitted. For example, an event or block with dashed lines in the figures can be optional or omitted. In some cases, an event or block with solid lines in the figures can still be optional or omitted if the event or block is not necessary. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, the “gap configuration” can be replaced by “preconfigured gap configuration”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method for configuring reference signal measurements at a UE, the method implemented in a central unit (CU) of a distributed base station that also includes a distributed unit (DU), the method comprising:
transmitting, to the DU, a first message including a request to configure a measurement gap for a UE;
receiving, from the DU, a second message including a measurement gap configuration; and
providing the measurement gap configuration to the UE, for use with the reference signal measurements.

2. The method of claim 1, wherein the measurement gap configuration includes:
a preconfiguration indicator to indicate that the the gap configuration is preconfigured.

3. The method of claim 1 or 2, wherein the measurement gap configuration includes:
a MeasGapConfig information element (IE).

4. The method of any of the preceding claims, wherein:
the first message includes a Measurement Preconfiguration Required message.

5. The method of any of the preceding claims, wherein:
the first message includes a Measurement Preconfiguration Confirm message.

6. The method of any of the preceding claims, further comprising:
receiving, from Location Management Function (LMF) and prior to the transmitting of the first message, a Measurement Preconfiguration Required message.

7. The method of claim 6, wherein:
the Measurement Preconfiguration Required message includes a Transmission-Reception Point (TRP) positioning reference signal (PRS) information; and
the transmitting of the first message to the DU includes transmitting the TRP PRS information to the DU.

8. The method of any of the preceding claims, further comprising, subsequently to the providing of the measurement gap configuration to the UE:
transmitting, to the DU, a request to activate the measurement gap configuration.

9. The method of claim 8, wherein:
the request includes a positioning reference signal (PRS) measurement information.

10. The method of claim 8 or 9, wherein:
the request to activate the measurement gap configuration is a Measurement Activation message.

11. The method of any of the preceding claims, wherein:
transmitting the first message includes transmitting one of a CU-to-DU message or an F1 Application Protocol (F1AP) message.

12. A method for configuring reference signal measurements at a UE, the method implemented in a distributed unit (DU) of a distributed base station that also includes a central unit (CU), the method comprising:
receiving, from the CU, a first message including a request to configure a measurement gap for a UE; and
transmitting, to the CU, a second message including a measurement gap configuration.

13. The method of claim 12, wherein:
the request to configure the measurement gap includes a Transmission-Reception Point (TRP) positioning reference signal (PRS) information; the method further comprising:
generating the measurement gap configuration using the TRP PRS information.

14. The method of claim 12 or 13, wherein:
the measurement gap configuration includes a gap identifier (ID).

15. A radio access network (RAN) node comprising processing hardware and configured to implement a method according to any of the preceding claims.
